(19) United States
(12) Patent Application Publication
(10) Pub. No.: US 2022/0241999 A1
(43) Pub. Date: Aug. 4, 2022

(54) METHOD FOR FOLDING A CUT SLICE AND SLICING MACHINE DESIGNED FOR THIS PURPOSE

(71) Applicant: MULTIVAC SEPP HAGGENMUELLER SE & CO. KG, Wolfertschwenden (DE)

(72) Inventors: Dominik MARX, Giessen (DE); Christian DERSCH, Breidenbach (DE)

(73) Assignee: MULTIVAC SEPP HAGGENMUELLER SE & CO. KG, Wolfertschwenden (DE)

(21) Appl. No.: 17/590,028

(22) Filed: Feb. 1, 2022

(30) Foreign Application Priority Data
Feb. 1, 2021 (DE) 102021102247.9

(51) Int. Cl. B26D 7/32

(52) U.S. Cl. CPC B26D 7/32

(57) ABSTRACT

In order not to have to set a folding shaft or another folding device correctly in many attempts for each new order, as many as possible of parameters influencing the folding process, be they folding parameters, cutting parameters and/or product parameters, which have produced a satisfactory actual shape of the folding of the slice and/or the shape and position of the portion produced therefrom in a processed order, are stored as a data record and, in the case of a new order, the parameters specified there are compared with corresponding parameters in the data bank in the data records and the data record most similar thereto is selected, the remaining parameters of which are then set, on the slicing machine for execution of the new order.

This can be done partially or completely automatically, for which, controllable control elements for each parameter are changed.

### CROSS-REFERENCE TO RELATED APPLICATION

This application claims priority to German Patent Application No. DE 102021102247.9 filed on Feb. 1, 2021, the disclosure of which is incorporated in its entirety by reference herein.

### TECHNICAL FIELD

The invention relates to slicing machines, in particular so-called slicers, with which strands of an only slightly compressible product such as sausage or cheese are sliced in the food industry.

### BACKGROUND

Since these strands can be produced with a cross section that retains its shape and dimensions well over its length, i.e. essentially constant, they are called product calibers.

In most cases, several product calibers arranged parallel to each other are cut at the same time by cutting one slice at a time from the same blade, which moves in a transverse direction to the longitudinal direction of the product calibers.

The product calibers are pushed forward by a feed conveyor of a cutting unit in the direction of the blade of the cutting unit, usually on an obliquely downwardly directed feed conveyor, and are each guided through the product openings of a plate-shaped, so-called cutting frame, at the front end of which the part of the product caliber projecting beyond it is cut off as a slice by the blade directly in front of the cutting frame.

As a rule, the slices fall onto a deposit surface, usually a discharge conveyor of a discharge unit, by means of which they are transported away for further processing.

Sometimes the slices are not to be deposited flat on the depositing surface, but folded about a folding axis lying parallel to the main plane of the slice, so that, viewed from the side, a sleeve is formed from the slice, open on both sides and having an approximately teardrop-shaped cross section.

Various folding devices are known for this purpose, which are arranged in the drop path of the slice, for example one or, according to EP 3 009 242 B1, two rotatably drivable folding shafts lying in the transverse direction to the fall path and also to the discharge direction of the discharge conveyor, onto which the slice strikes with its upper region when it falls, which is thereby folded over onto the lower region of the slice.

It is difficult to obtain the desired folding pattern, i.e. the shape of the folded slice in the transverse direction and its position on the delivery surface, also relative to the transverse direction and, if necessary, also to the discharge conveyor direction, since for this purpose the folding of the slice is somewhat different in each case, depending on the physical parameters of the slice, such as adhesion, elasticity, thickness, temperature, length of the drop path, as well as distance and inclination of the deposit surface from the cutting point.

Therefore, at least for each new batch of product calibers to be sliced, the folding device must be readjusted with regard to its position and, if necessary, also its adhesion and friction properties, which is usually done manually and requires a great deal of time due to multiple trials and changes of the settings, in the meantime the slicing machine must be brought to a standstill again and then restarted, not to mention the incorrect batches of slices produced.

### SUMMARY

It is therefore the object of the invention to provide a folding method and a slicing machine, in particular a slicer, which is capable of countering the above-mentioned problem and at the same time exhibits a high degree of process reliability.

With regard to the method for folding an article such as a slice when dropping it from the cutting unit onto a deposit surface by means of a transverse folding shaft, the object is solved by relying on stored empirical values from the past for a new slicing and folding job, or at least by starting from these empirical values for an adjustment of the cutting unit:

The parameters to be considered are:

A: product parameters concerning the product caliber to be cut, in particular
temperature of the caliber, especially at the face where a slice is to be cut,
adhesion,
elasticity,
slice thickness,

B: the cutting parameters influencing the cutting process, in particular those to be set on the cutting unit, in particular
speed of the blade,
shape of the blade, in particular the cutting edge,
feed speed of the blade in the direction of immersion,
static friction of the blade,

C: the folding parameters influencing the folding process and adjustable on the folding unit, in particular the folding shaft, in particular
position of the folding unit, in particular the folding shaft, in the height above the deposit surface and in the transport direction to the deposit surface,
the deposit surface, in particular the portioning belt
tilting position of the folding shaft about a vertical axis and/or about the transport direction.

An order for slicing product calibers and folded depositing of the generated slices is understood as the scope of work within which the mentioned parameters do not change to such an extent that they significantly influence the folding process, usually the slicing of a batch of similar product calibers.

According to the invention, the parameters used during a job, which resulted in an actual fold that was within the tolerance range of the specified target fold, are thus stored as a data record.

When a new order is received, the specified parameters, in particular product parameters and specified nominal fold, in particular nominal fold shape, are compared with the relevant nominal folds and/or parameter combinations stored in the data records, and the data record with the most similar parameter combination to the specified parameters is selected for an initial setting of the slicing machine, which can then be fine-tuned. Priority is given in particular to comparing the target folds specified for the new job with the target folds stored in the data sets.

Substantially, this should result in actual folds that lie within the tolerance range of the nominal fold.

In the case of a multi-track slicing machine in which different jobs are performed on the individual tracks, e.g. different product calibers are sliced, it is preferable to determine and store the parameters and select the correct data set separately for each track.

The parameters prevailing during a job can be partly transferred directly from the control into the data set to be stored, for example the used speed of the blade or the used immersion speed, or they can also be entered manually from the beginning, for example the shape of the blade or the product parameters.

The slicing machine can also have sensors for determining certain parameters, in particular the product sensors, the folding parameters and/or the blade parameters, which are then transferred and stored by the control in the corresponding data record.

Above all, the actual state of the folded article, in particular the actual fold shape, is preferably detected by means of a sensor, in particular by means of a camera that records the actual fold shape from above and/or from the side.

In the event of a deviation of the actual state from the nominal state of the folded article, the control automatically changes one or more of the selectable parameters until the actual state lies within the tolerance range of the nominal state, whereby the operator can additionally intervene manually, for example by specifying the direction of change of a parameter, i.e. increasing or decreasing.

This significantly reduces the manual effort required for setting a folding device.

In a multi-track slicing machine, the target/actual comparison of the corresponding parameters as well as the change of the parameters—if the actual shape is not satisfactory—should be carried out separately for each track, if possible, in order to achieve the desired result on each track.

The folding process can be supported by a defined applied air flow, which acts on the slice or portion in such a way that the desired folding is achieved. Preferably, the air flow is supplied by the folding shaft and discharged from the circumference of the folding shaft against the slice.

With regard to the slicing machine—which as usual comprises a cutting unit, a feeding unit for feeding the calibers as well as a discharge unit for discharging the sliced slices and a control for controlling moving parts of the slicing machine—a folding unit is additionally provided, which preferably has a rotatable folding shaft.

Then the existing object can be solved by the control comprising a memory unit which is embodied to store data records comprising at least the desired state of the folded article, i.e. the target shape, as well as the folding parameters concerning the folding unit, preferably additionally also the product parameters and/or the blade parameters.

In order that a parameter comparison does not have to be carried out and evaluated completely manually by the operator, the control preferably also comprises a comparison algorithm which is embodied to compare predetermined parameters of a new order with parameters stored in the data sets and to determine the data set which is most similar to the predetermined parameters, so that the parameters further specified in this data set can be realized at the machine, which should then result in a satisfactory actual shape of the folded articles.

Preferably, the slicing machine also comprises sensors to automatically determine some of the relevant parameters, in particular product parameters and/or blade parameters and/or folding parameters, at the machine and to make them available to the control for storage within a data set.

It is also advantageous if the slicing machine has control elements for changing the position of parts of the folding unit, such as the position of the folding shaft, which can be actuated from the control and can be set by the control on the basis of the parameters in the selected data record, in order to keep the number of parameters to be set manually as low as possible.

To support the folding process, the folding unit can also comprise outlet openings for compressed air, preferably in the peripheral surface of the folding shaft, in order to allow an air flow which can be controlled in terms of time and/or flow rate and/or pressure to act on the slice during the folding process.

Preferably, the air flow generator is located outside the folding shaft for this purpose, but the compressed air is supplied to the outlet openings there via air ducts in the folding shaft.

### BRIEF DESCRIPTION OF THE DRAWINGS

Embodiments according to the invention are described in more detail below by way of example. They show:

FIGS. 1a, b: a slicing machine in the form of a slicer according to the prior art in different perspective views, with the feed belt tilted up into the slicing position,

FIG. 1c: the slicing machine of FIGS. 1a, b in side view with the cover parts removed so that the different conveyor belts can be seen more clearly,

FIG. 2a: a simplified side view of the slicing machine compared to FIG. 1c, loaded with a product caliber,

FIG. 2b: a side view as in FIG. 2a, but with the infeed belt tilted down into the loading position and with the product caliber cut open except for a caliber remnant,

FIG. 3: an enlarged side view according to FIGS. 2a, b with a known optical detection of the deposited articles,

FIG. 4a: a representation analogous to FIG. 3 with an additional folding unit according to the invention,

FIG. 4b: an enlarged side view according to FIG. 4a,

FIG. 5: a top view of the upstream part of the discharge unit with the folding unit arranged in this area,

FIG. 6a: viewed in the opposite direction to the passage direction of a two-track slicing machine, the delivery unit, the blade and the folding shaft, which is the only one here.

FIG. 6b: Viewed against the passage direction of a two-track cutting machine, the feed unit, the blade and the folding shaft assigned to each track.

### DETAILED DESCRIPTION

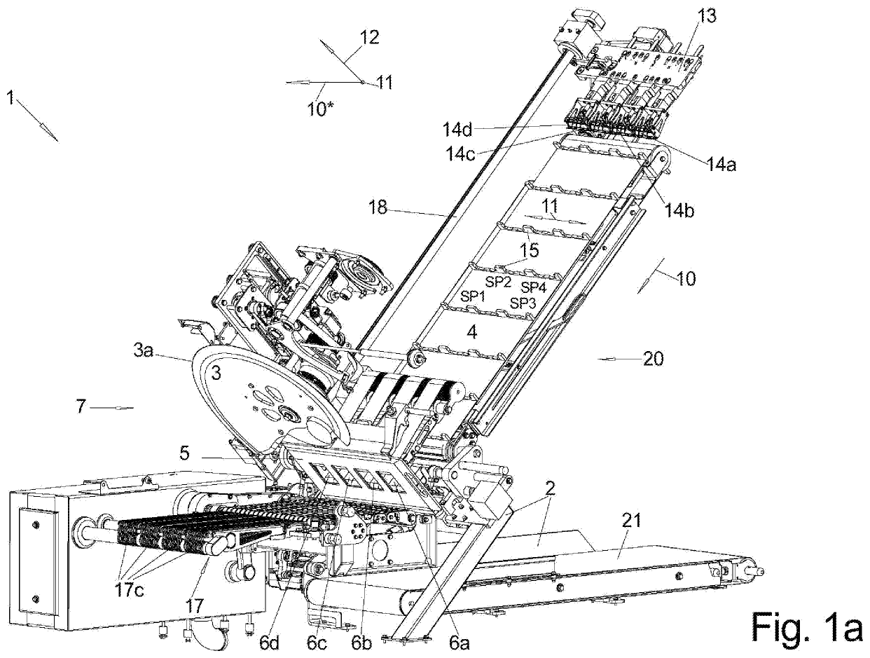

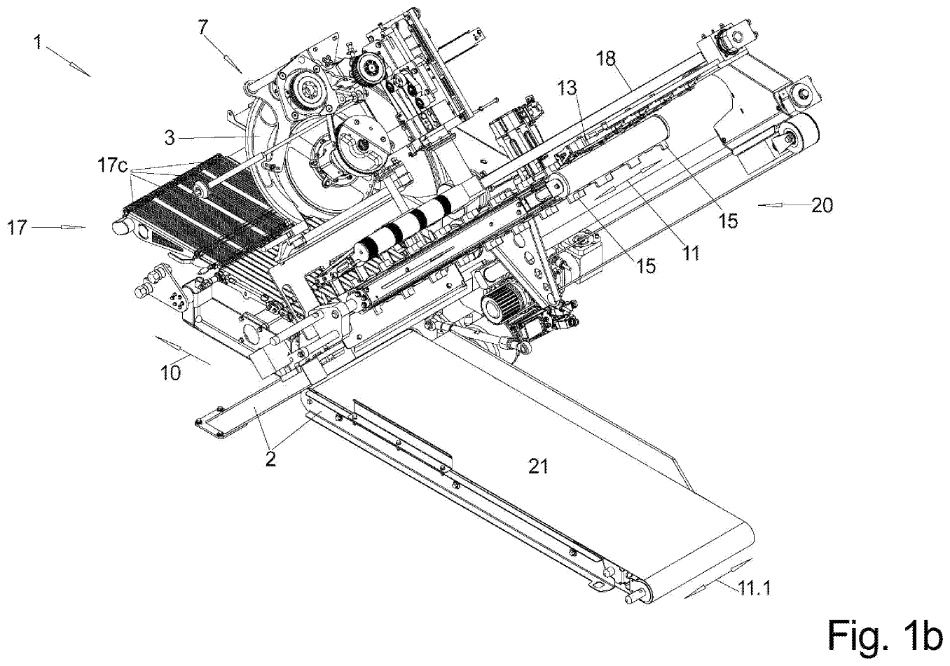

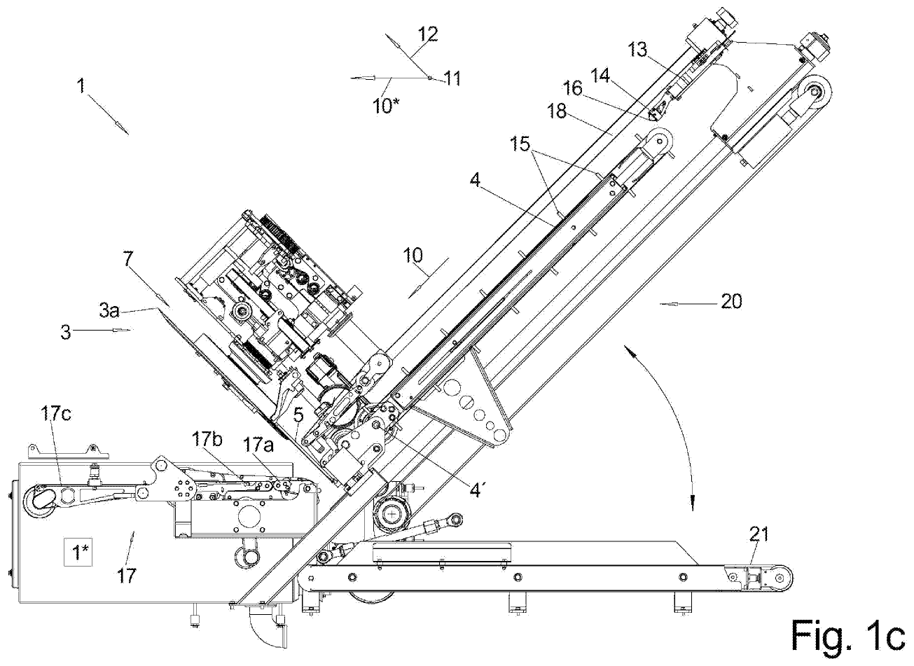

FIGS. 1a, 1b show different perspective views of a multi-track slicer 1 for simultaneous slicing of several product calibers K on one track SP1 to SP4 next to each other and depositing in shingled portions P of several slices S each with a general passage direction 10* through the slicer 1 from right to left.

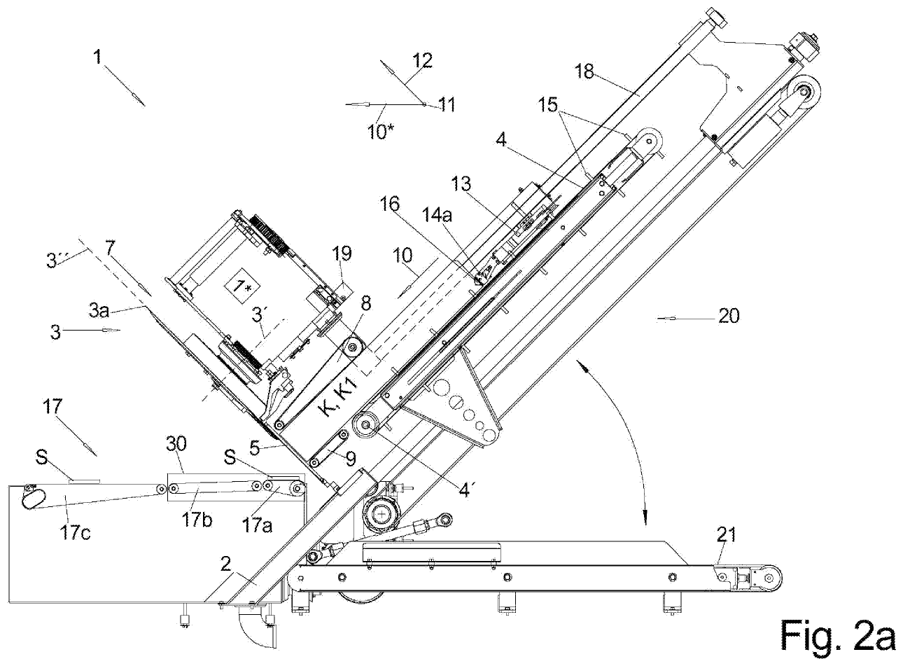

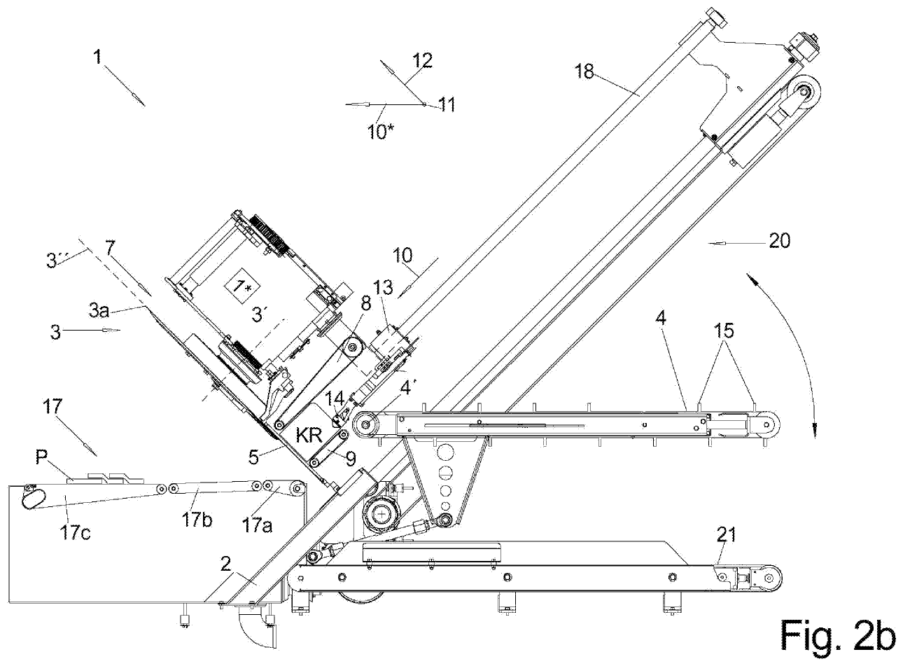

FIG. 1c and FIG. 2a show—without and with the caliber K inserted—a side view of this slicer 1, omitting covers and other parts not relevant to the invention, which are attached to the base frame 2 like all other components, so that the functional parts, especially the conveyor belts, can be seen more clearly. The longitudinal direction 10 is the feeding direction of the calibers K to the cutting unit 7 and thus also the longitudinal direction of the calibers K lying in the slicer 1.

It can be seen that the basic structure of a slicer 1 according to the state of the art is that to a cutting unit 7 with a blade 3 rotating about a blade axis 3′, such as a sickle blade 3, several, in this case four, product calibers K, lying side by side transversely to the feeding direction 10 on a feed conveyor 4 with spacers 15 of the feed conveyor 4 between them are fed by this feed unit 20, from the front ends of which the rotating blade 3 cuts a slice S with its cutting edge 3a from each caliber in one operation, i.e. almost simultaneously.

For cutting the product calibers K, the feed conveyor 4 is in the cutting position shown in FIGS. 1a-2a, which is oblique in side view with a low-lying front end on the cutting side and a high-lying rear end, from which it can be tilted down about a pivot axis 20′ running in its width direction, the first transverse direction 11, which is located in the vicinity of the cutting unit 7, into an approximately horizontal loading position as shown in FIG. 2b.

The rear end of each caliber K lying in the feed unit 20 is held positively by a gripper 14a-d with the aid of gripper claws 16 as shown in FIG. 2a. These grippers 14a-14d, which can be activated and deactivated with respect to the position of the gripper claws 16, are attached to a common gripper slide 13, which can be moved along a gripper guide 18 in the feeding direction 10.

Both the feed of the gripper slide 13 and of the feed conveyor 4 can be driven in a controlled manner, but the actual feed speed of the calibers K is effected by a likewise controllably driven so-called upper and lower product guide 8, 9, which engage on the upper side and lower side of the calibers K to be cut open in their front end regions near the cutting unit 7:

The front ends of the calibers K are each guided through a so-called slit opening 6a-d of a plate-shaped cutting frame 5, the cutting plane 3″ running immediately in front of the front, obliquely downward-pointing end face of the cutting frame 5, in which cutting plane the blade 3 rotates with its cutting edge 3a and thus cuts the protrusion of the calibers K from the cutting frame 5 as a slice S. The cutting plane 3″ runs perpendicular to the upper run of the feed conveyor 4 and/or is spanned by the two transverse directions 11, 12 to the feeding direction 10.

The inner circumference of the product openings 6a-d serves as a counter cutting edge for the cutting edge 3a of the blade 3.

Since both product guides 8, 9 can be driven in a controlled manner, in particular independently of each other and/or possibly separately for each track SP1 to SP4, they determine the—continuous or clocked—feed speed of the calibers K through the cutting frame 5.

The upper product guide 8 is displaceable in the 2. transverse direction 12—which is perpendicular to the surface of the upper run of the infeed conveyor 4—for adaptation to the height H of the caliber K in this direction. Furthermore, at least one of the product guides 8, 9 can be embodied to pivot about one of its deflection rollers in order to be able to change the direction of the strand of its guide belt lying against the caliber K to a limited extent.

The slices S standing inclined in the space during separation fall onto a discharge unit 17 starting below the cutting frame 5 and running in passage direction 10*, which in this case consists of several discharge conveyors 17a, b, c arranged one behind the other with their upper runs approximately aligned in passage direction 10*, of which the first discharge conveyor 17a in passage direction 10 can be embodied as portioning belt 17a and/or one can also be embodied as weighing unit.

The slices S can hit the discharge conveyor 17 individually and at a distance from each other in the passage direction 10* or, by appropriate control of the portioning belt 17a of the discharge conveyor 17—the movement of which, like almost all moving parts, is controlled by the control 1*—form shingled or stacked portions P, by stepwise forward movement of the portioning belt 17a.

Below the feed unit 20 there is usually an approximately horizontally running rest piece conveyor 21, which starts with its front end below the cutting frame 5 and directly below or behind the discharge unit 17 and with its upper run thereon—by means of the drive of one of the discharge conveyors 17 against the passage direction 10—transports falling rest pieces downwards.

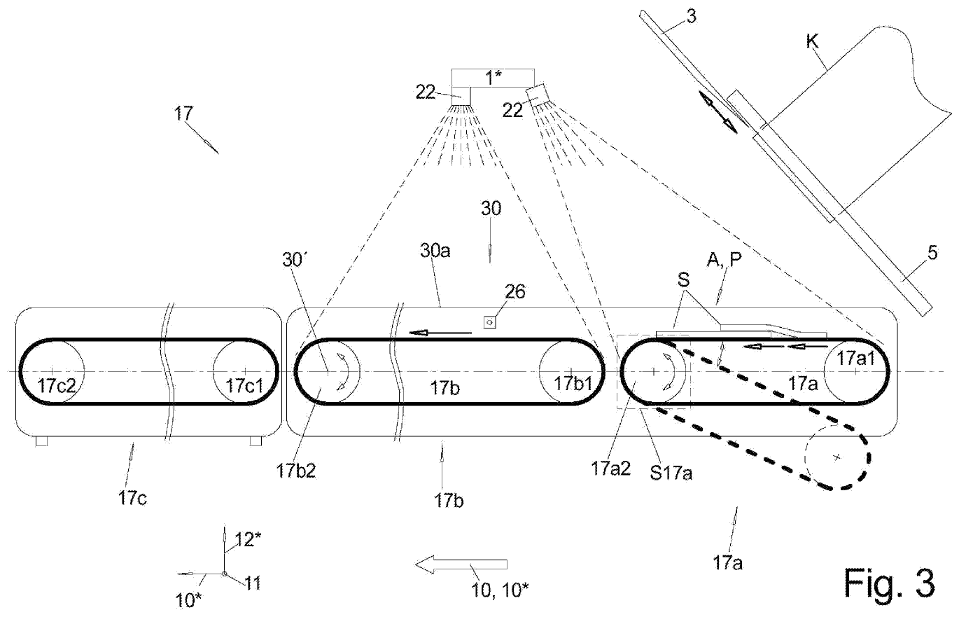

FIG. 3 shows in side view only the discharge unit 17 of the slicing machine 1 in one embodiment:

In the transport direction 10, in which the articles A—here a portion P consisting of only two shingled slices S—are to be conveyed away from the discharge unit 17 and which is at the same time the direction of travel 10* through the entire slicing machine 1, three discharge conveyors 17a, b, c are present in succession. The article A lies on the upper runs of these respective endlessly circulating belts, which circu-late via an upstream deflection roller 17a1, 17b1, 17c1 and a downstream deflection roller 17a2, 17b2, 17c2 in the transport direction 10, for removal and transfer to the respective next discharge conveyor.

The excess of the caliber K projecting downward from the inclined cutting frame 5 is cut off by the blade 3, and the slice S falls onto the portioning belt 17a, which is advanced one step at a time to produce a shingled portion P in the direction of transport 10 after each slice S has been hit.

When the article A to be produced has been completed on the portioning conveyor 17a, the latter is set in motion and the article A is transferred to the subsequent discharge conveyor 17b.

The first two discharge conveyors 17a, 17b are usually mounted and supported in a pivot unit 30, usually in its pivot frame 30a, which is usually pivotable about a pivot axis 30′ disposed near its downstream end. In addition, the portioning belt 17a is usually pivotable about a pivot axis extending in the transverse direction 11 and located in the downstream end region of the portioning belt 17a relative to the pivot frame 30a.

The drives for driving the discharge conveyors and pivoting them are not shown.

A camera 22 is arranged above the discharge unit 17—two of which are shown at alternative positions in FIG. 3—and which is data-coupled to the control 1* of the slicing machine 1, and with which the actual position of the article A on the respective discharge conveyor 17a and/or 17b is to be recorded and detected.

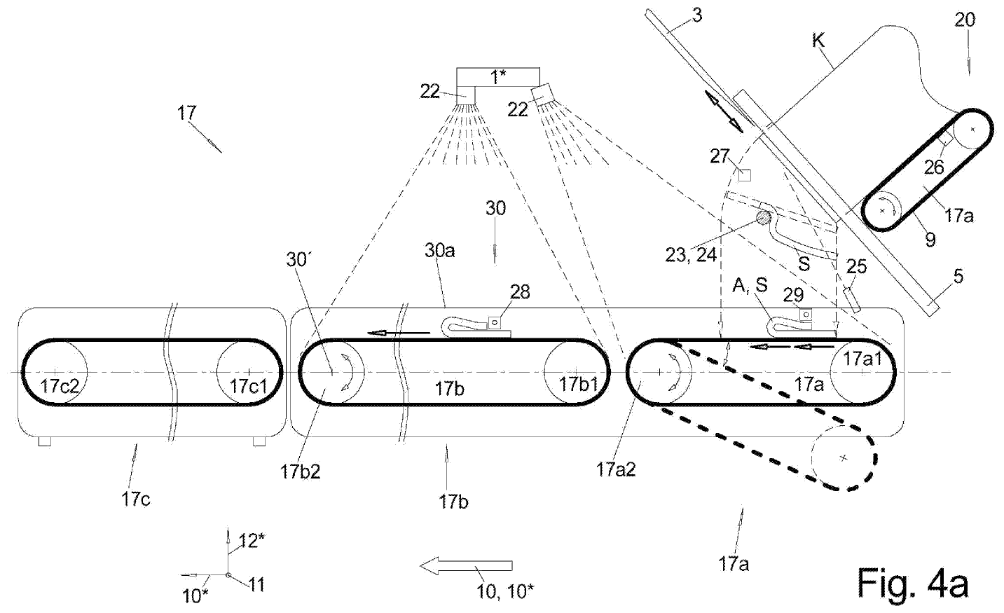

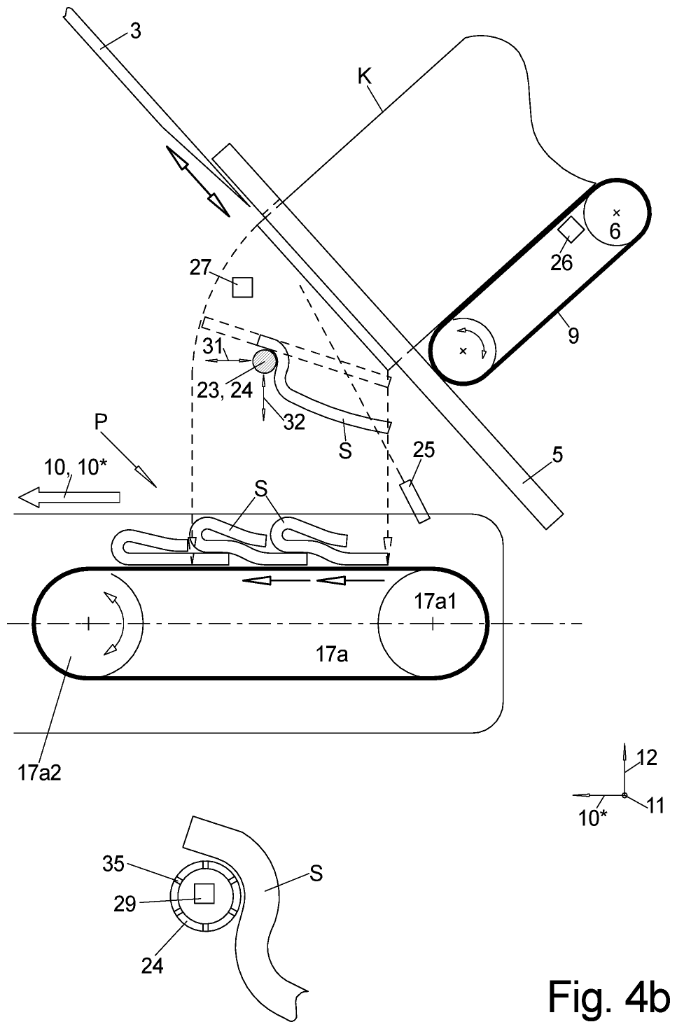

In FIG. 4a, in addition to the otherwise identical representation of FIG. 3, a folding shaft 24 known per se is shown as a folding unit 23 in the fall path of the slice S cut off in front of the caliber K down onto the portioning belt 17a, and likewise in FIGS. 4b to 6b.

This folding axle 24 extends approximately in the horizontal transverse direction to the passage direction 10*, so that its upper part, first separated from the caliber K, first meets the folding shaft 24, but because of the further downward falling lower part of the slice S is folded around by this onto the lower part of the slice and thus a slice, folded as a C-shape in the side view according to FIGS. 4a, b, comes to lie on the portioning belt 17a.

The position of the folding shaft 24 can be adjusted in the passage direction 10* as well as in the vertical 12* in order to influence the actual shape of the folding achieved.

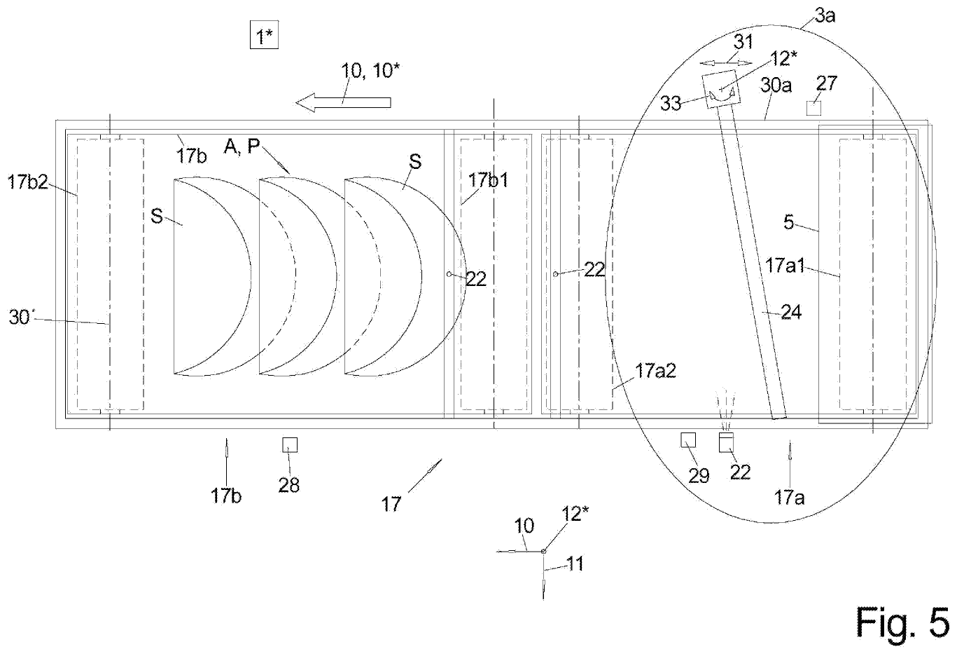

For example, the position in the passage direction 10* is usually selected in such a way that, in the folded slice S, the superimposed edges of the slice parts do not come to lie congruently on top of one another, but the folded-over upper part of the slice is shorter than the underlying part of the slice, as shown in FIGS. 4a to 5.

Furthermore, the folding shaft 24 is often at least freely rotatable, preferably driven in rotation, about its longitudinal extension, i.e. approximately the transverse direction 11, in order to support this folding process and, above all, not to brake the falling of the lower, last separated part of the slice S.

FIG. 4b shows the folding process in enlarged representation, whereby in this case portions P are produced on the portioning belt 17a from shingled, in each case folded, slices S, in which the bent-over part of the next slice rests on the projection of the lower slice part relative to the upper slice part of a slice, as can also be seen clearly in FIG. 5 in the plan view of the first two discharge conveyors 17a, 17b of the discharge unit 17.

As shown in the enlargement in FIG. 4b, the folding shaft 24 is not only driven in rotation about its longest direction of extension—preferably with a peripheral speed which is equal to or greater than the falling speed of the slice S—but is frequently also formed as a hollow tube, in the wall of which, distributed over the circumference as well as the length of the tube, air outlets 35 are present, through which air intro-duced with overpressure into the interior of the hollow folding shaft 24 flows out and thereby prevents or at least minimizes the adhesion of the slice S to the folding axle 24.

The introduction of separating air in this manner between folding shaft 24 and slice S is independent of whether the folding shaft 24 is driven in rotation about its longitudinal extent or is merely freely rotatable or non-rotatable.

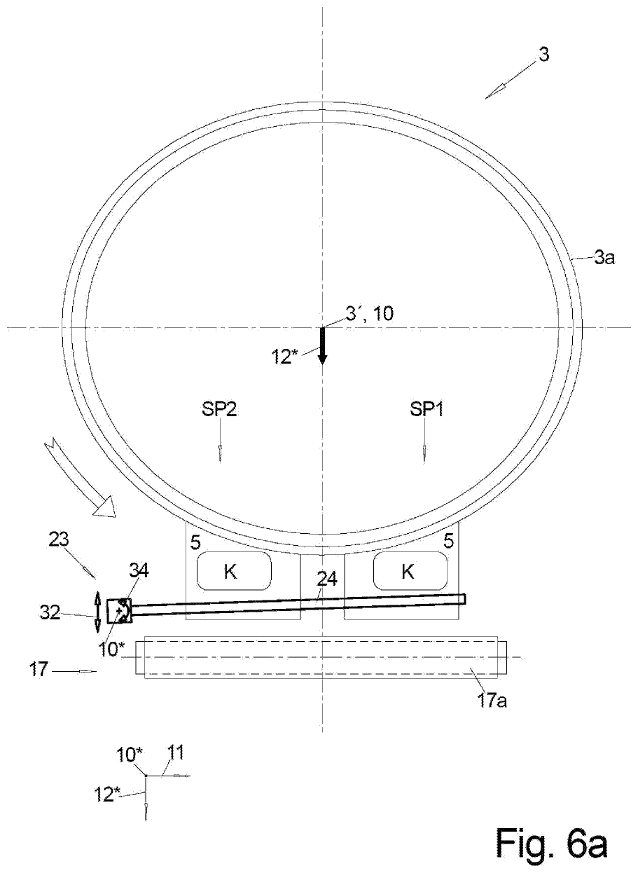

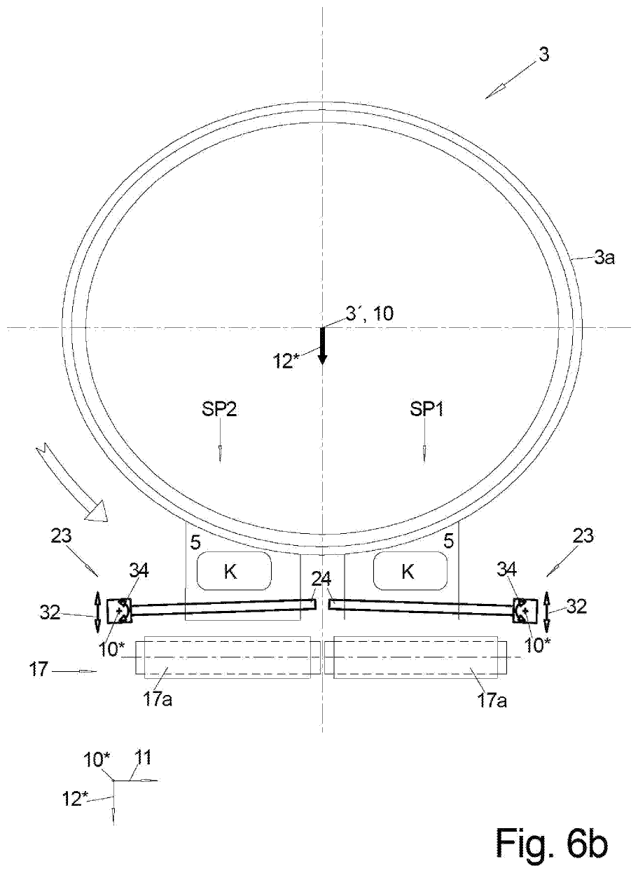

FIG. 5 shows in plan view that the folding shaft 24 does not have to run exactly in the transverse direction 11, but can be set at an acute angle thereto, which is often necessary to compensate for the twist of the falling slice S caused by the rotation of the blade 3 or other influencing factors and to deposit the slice S in the desired orientation in the passage direction 10* and transverse direction 11 on the portioning belt 17a and thus also on the subsequent discharge conveyor 17b.

Whereas the top view of FIG. 5 shows part of a single-track discharge conveyor 17, FIGS. 6a, b show the folding unit 23 on a two-track slicing machine 1 viewed against the passage direction 10*.

It can be seen in FIG. 6a that the folding shaft 24 extends in the transverse direction 11 over all tracks SP1, SP2 and, by pivoting about an axis running in the passage direction 10*, can also be adjusted from the position aligned with the transverse direction 11 in this view to a defined acute angle rising inclined thereto.

It can also be seen that in this case there is a common discharge conveyor unit 17 for both tracks Sp1, Sp2, of which only the portioning belt 17a passing over both tracks Sp1, Sp2 in transverse direction 11 is visible here.

However, with a folding shaft 24 extending over both tracks Sp1 and Sp2, the result of the folding on the individual two tracks cannot be changed independently of each other.

FIG. 6b, on the other hand, shows a solution in which the two tracks Sp1, Sp2 can be driven and controlled independently of each other.

For this purpose, there is a separately controllable portioning belt 17a for each track Sp1, Sp2, and also a separate folding unit 23 with folding shaft 24 for each track Sp1, Sp2. The folding shaft 24 is fastened in each case on the outer side of the associated track facing away from the other track and can be adjusted there as described about the vertical axis, preferably the vertical 12*, as well as in passage direction 10*, and projects with its free end over the width range of the caliber K to be cut open on this track.

Furthermore, various sensors 25-28 are shown in FIGS. 4a, b in order to determine as many parameters as possible, preferably product parameters relating to the caliber K, automatically and preferably without contact:

Thus, by means of a sensor 25—which can be located, for example, on the base frame of the machine—the temperature of the front surface of the caliber K to be cut can be measured. Before the caliber K is cut, this is the surface temperature, and after the first few centimeters have been cut off—if this is done quickly enough—it is the core temperature of the caliber K. The temperature influences the adhesion of the slice S to the blade 3 and also the bending stiffness of the slice S and thus the shape of the folded slice S.

For this purpose, a sensor 28, 29—preferably a camera—whose measuring direction is an approximately horizontal transverse direction, can detect the shape of the fold of a folded slice S for the purpose of comparison with a nominal shape of a folded slice S. Such a sensor 28 can be located in the length range of the central conveyor 17b or, as sensor 29, in the length range of the portioning belt 17a.

With the same viewing direction, a sensor 27 with its detection direction in transverse direction 11 can be arranged between cutting frame 5 and portioning belt in the discharge path of the slices S, which in the side view detects the deflection of the falling slice, from which the bending stiffness of this slice S can also be con-cluded.

In order to determine the salt content of the caliber and/or the electrical conductivity of the caliber and from this the water content, a sensor 26 contacting the caliber K is usually necessary, which can be arranged in the feed unit 20 for the caliber K, for example in the area of the driven bottom product guide 9.

It is not shown in the drawing that the control 1* of the slicing machine 1 is not only supplied with signals from the sensors 25 to 28 as well as the images of the camera 22, but preferably has a comparison algorithm which compares the actual state of the folding determined by the at least one camera 22—possibly viewed in the top view as well as in the transverse direction 11—with a predetermined target state.

In the event that the actual state is outside a tolerable range with respect to the desired state of the fold—in each case differentiated according to positioning in the two horizontal spatial directions as well as rotation about an upright axis such as the vertical 12*—the control 1* can for this purpose actuate existing control elements 31 to 34, such as servo motors—in order to adjust the folding axle 24 in the passage direction 10*, in the height 12 and in the pivoted position about the passage direction 10* and the vertical 12* in such a way that the actual state of the individual folded slices S and/or of the portion P made from several such folded slices S corresponds to the target state, i.e. lies within the tolerance range of the target state.

Even if no such controllable control elements 31 to 34 are present, but the adjustment of the folding shaft 24 must be carried out manually, the control 1* can at least give the operator information via its display device as to which adjustment of the folding shaft 24 he must manually change in which direction, and if necessary also how much.
1 slicing machine, slicer
1* control
2 base frame
3 blade
3 rotation axis
3″ blade plane, cutting plane
3a cutting edge
4 feed conveyor, feed belt
5 cutting frame
6a-d product opening
7 cutting unit
8 upper product guide, upper guide belt
8.1 contact run, lower run
8a cutting side deflection roller
8b deflection roller facing away from the cutting side
9 bottom product guide, lower guide belt
8.1 contact run, upper run
9a cutting side deflection roller
9b deflection roller facing away from the cutting side
10 transport direction, longitudinal direction, axial di-reaction
10* passage direction
11 1. transverse direction (width slicer)
12 2. transverse direction (height-direction caliber)
12* vertical
13 gripper unit, gripper slide
14,14 a-d gripper
15 spacer
16 gripper claw
17 discharge conveyor unit
17a, b, c discharge conveyor, discharge conveyor
18 gripper guide
19 height sensor
20 feed unit
21 end piece conveyor
22 camera
23 folding unit
24 folding shaft
25 sensor
26 sensor
27 sensor
28 sensor
29 compressed air source
30 pivot unit
30a pivot frame
30′ pivot axis
31 control element
32 control element
33 control element
34 control element
35 air outlet
A article
K product, product caliber
KR end piece
S slice
P portion
SP1-SP4 track

1. A method for folding an article comprising a slice or a portion, which has been cut from a product caliber by a slicing machine, in that
the article is dropped onto a depositing surface,
a folding unit, comprising a folding shaft, is arranged transversely in a path of fall of the slice in such a way that the slice is deposited folded on the depositing surface,
the method comprising:
in a case of an individual job, storing folding parameters which have resulted in an actual state of a fold within a tolerance range in a data record together with product parameters and blade parameters prevailing at that time,
in a case of a new job, comparing at least a specified target state comprising the product parameters prevailing at that time with the stored data records, and from a most similar data record the folding parameters are used for carrying out the new job,
wherein the blade parameters are also preset for the new job and are taken into account in selection of the data record or are not preset and are taken from a selected data record.

2. The method according to claim 1,
further comprising,
in a multi-track slicing machine, storing the folding parameters and/or the product parameters for each track individually as a data record.

3. The method according to claim 1,
further comprising
detecting the actual state of a folded slice with respect to position and/or shape and/or size is,
comparing the detected actual state with a predetermined target state,
if the actual state deviates from the target state by more than a predetermined tolerance value, automatically changing the folding parameters in such a way that the actual state lies within the tolerance range of a desired state.

4. The method according to claim 1,
wherein
in a case of a multi-track slicing machine, the target/actual comparison and the change in parameters are carried out separately for each track.

5. The method according to claim 1,
wherein
the folding process is supported by a defined air flow,
the method further comprising supplying the air flow by the folding unit, and directing the air flow against the slice.

6. A slicing machine, for slicing calibers into slices, the slicing machine comprising:
a cutting unit,
a feed unit for feeding at least one product caliber to the cutting unit,
a discharge unit with a portioning belt under the cutting unit
a folding unit with a folding shaft for folding a slice during discharge onto the discharge unit
a control for controlling moving parts of the slicing machine,
wherein
the control comprises a memory unit for storing data records which contain at least
a target state of a folded slice and/or of a shape and/or position of a portion created therefrom
folding parameters
and/or
product parameters
and/or
blade parameters
as data.

7. The slicing machine according to claim 6, wherein
the control comprises a comparison algorithm capable of comparing predetermined parameters with parameters stored in data sets and of determining the data set most similar to predetermined parameters.

8. The slicing machine according to claim 6,
wherein
the slicing machine comprises sensors for automatically detecting an actual state of the folded slice and/or the shape and/or position of the portion made therefrom, and/or product parameters.

9. The slicing machine according to claim 8,
wherein
the slicing machine has control elements for positioning the folding unit,
the control is designed in such a way that it can automatically set the cutting parameters and folding parameters contained in a most similar data set by actuating corresponding control elements on the slicing machine,
in a case of a multi-track slicing machine, separately for each track.

10. The slicing machine according to claim 6,
further comprising
a compressed air source,
which supplies, outlet openings in a circumferential surface of the folding shaft with air which is under a higher pressure than ambient pressure.

11. The method according to claim 1, wherein the depositing surface is part of a discharge unit.

12. The method according to claim 3, wherein detecting the actual state of the folded slice comprising optically detecting the actual state of the folded device.

13. The method according to claim 3, wherein automatically changing the folding parameters comprises automatically changing the folding shaft parameters.

14. The method according to claim 5, wherein supplying the air flow by the folding unit comprises supplying the air flow by the folding shaft.

15. The slicing machine according to claim 6, wherein the slicing machine is for producing shingled or stacked portions from slices.

16. The slicing machine according to claim 8, wherein the sensors are further for automatically detecting cutting parameters and/or folding parameters.

17. The slicing machine according to claim 9, wherein the control elements are for positioning the folding shaft in a height and a transport direction, including a pivoting position about the transport direction and/or about a vertical axis.

18. The slicing machine according to claim 10, wherein the compressed air source supplies the outlet openings via air ducts in the folding shaft.

19. A method for folding an article comprising a slice or a portion, which has been cut from a product caliber by a slicing machine, wherein the article is dropped onto a depositing surface, wherein a folding unit comprising a folding shaft, is arranged transversely in a path of fall of the slice in such a way that the slice is deposited folded on the depositing surface, the method comprising:
in a case of an individual job, storing folding parameters which have resulted in an actual state of a fold within a tolerance range in a data record together with product parameters and blade parameters prevailing at that time; and
in a case of a new job, comparing a specified target state comprising the product parameters prevailing at that time with the stored data records, wherein the folding parameters from a most similar data record are used for carrying out the new job.

20. The method according to claim 19 wherein the blade parameters are also preset for the new job and are taken into account in selection of the data record, or are not preset and are taken from a selected data record.
